(19) United States
(12) Patent Application Publication
(10) Pub. No.: US 2010/0060592 A1
(43) Pub. Date: Mar. 11, 2010

(54) Data Transmission and Reception Using Optical In-LCD Sensing

(76) Inventors: Jeffrey Traer Bernstein, San Francisco, CA (US); Brian Lynch, Portola Valley, CA (US)

Correspondence Address: APPLE C/O MORRISON AND FOERSTER ,LLP;LOS ANGELES, 555 WEST FIFTH STREET SUITE 3500, LOS ANGELES, CA, 90013-1024, US

(21) Appl. No.: 12/208,332

(22) Filed: Sep. 10, 2008

(51) Int. Cl. G06F 3/041; H04M 1/00; G06F 11/34

(52) U.S. Cl. 345/173; 455/566; 714/704; 714/E11.189

(57) ABSTRACT

Data transmission and reception through optical in-LCD sensing panels is provided. The transmission/reception can be a communication in which data is transmitted by displaying, on display pixels of the panel, a communication image encoding the data, and data is received by capturing, with EM sensors embedded in the panel, a communication image encoding the data that is displayed in proximity to the panel. The transmission/reception can be a scan in which a motion of a handheld device is determined by scanning a surface with the EM sensors at different times and comparing the corresponding scan images to obtain the motion of the device. A control signal based on the motion of the handheld device can be transmitted to an external device, for example, to control a mouse cursor. In another example, scan images can be combined based on the motion to generate a combined scan image of a surface.

### FIELD OF THE INVENTION

This relates generally to the use of optical in-LCD sensing panels, and more particularly, to configurations that allow transmission and/or reception of data, such as data communication and scanning, using optical in-LCD sensing panels.

### BACKGROUND OF THE INVENTION

Many types of input devices are presently available for performing operations in a computing system, such as buttons or keys, mice, trackballs, joysticks, touch sensor panels, touch screens and the like. Touch screens, in particular, are becoming increasingly popular because of their ease and versatility of operation as well as their declining price. Touch screens can include an optical in-LCD sensing panel, which can be a liquid crystal display (LCD) with embedded photodiodes. Touch screens can allow a user to perform various functions by touching the touch sensor panel using a finger, stylus or other object at a location dictated by a user interface (UI) being displayed by the display device. In general, touch screens can recognize a touch event and the position of the touch event on the touch sensor panel, and the computing system can then interpret the touch event in accordance with the display appearing at the time of the touch event, and thereafter can perform one or more actions based on the touch event.

However, with the exception of conventional configurations directed to sensing touch input, optical in-LCD sensing panels have found limited use.

### SUMMARY OF THE INVENTION

Configurations using optical in-LCD sensing panels can provide transmission and/or reception of data. In one transmit/receive configuration, an optical in-LCD sensing panel can be used for communication. Data is transmitted by displaying a communication image encoding the data on the sensing panel, and data is received by capturing, with the EM sensors embedded in the panel, a communication image displayed in proximity to the panel. In another configuration, data is received by scanning an object using an optical in-LCD sensing panel. The motion of a handheld device including the panel can be determined by scanning a surface with the EM sensors at different times and comparing the corresponding scan images. A control signal based on the motion of the handheld device can be transmitted to an external device, for example, to control a mouse cursor. In another configuration, scan images can be combined based on the motion to generate a combined scan image of a surface.

### BRIEF DESCRIPTION OF THE DRAWINGS

FIG. 1 shows an example display panel with embedded electromagnetic (EM) sensors that can be used in embodiments of the invention.

FIG. 2 shows example methods for improving the operation of a display panel with embedded EM sensors.

FIG. 3 shows an example device according to embodiments of the invention.

FIG. 4 is a block diagram showing more details of the example device of FIG. 3.

FIG. 5 is a flowchart of a method of communication according to embodiments of the invention.

FIG. 6 shows an example orientation of devices for data communication according to embodiments of the invention.

FIG. 7 shows an example orientation of a device for a user input function according to embodiments of the invention.

FIG. 8 is a flowchart of an example method of input according to embodiments of the invention.

FIG. 9 is a flowchart of an example method of scanning a surface according to embodiments of the invention.

FIG. 10a illustrates an example mobile telephone including an optical in-LCD sensing panel and configured to operate according to embodiments of the invention.

FIG. 10b illustrates an exemplary digital media player including an optical in-LCD sensing panel and configured to operate according to embodiments of the invention.

FIG. 10c illustrates an exemplary personal computer including an optical in-LCD sensing panel and configured to operate according to embodiments of the invention.

### DETAILED DESCRIPTION OF THE PREFERRED EMBODIMENTS

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

This relates to the use of optical in-LCD sensing panels, and more particularly, to configurations that transmit and/or receive data using optical in-LCD sensing panels. One transmit/receive configuration can be a communication configuration in which data is transmitted by displaying a communication image encoding the data on the sensing panel. Data can be received by capturing, with the EM sensors, a communication image displayed in proximity to the sensing panel. In another configuration, data can be received by scanning an object using an optical in-LCD sensing panel.

Although embodiments of the invention may be described and illustrated herein in terms of optical in-LCD sensing panels, it should be understood that embodiments of this invention are not so limited, but are additionally applicable to different types of panel displays (in addition to LCD-type displays) that include embedded EM sensors. Likewise, embodiments of this invention are not limited to “LCD”-type displays with embedded EM sensors, but may include other types of display panels with embedded EM sensors.

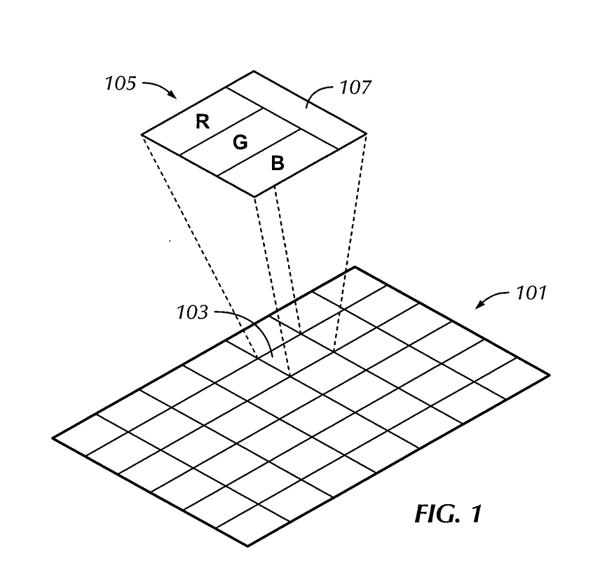

FIG. 1 shows a portion of an example optical in-LCD sensing panel 101 that includes pixels 103. An enlarged view of a pixel 103 shows that each pixel in panel 101 includes red (R), green (G), and blue (B) sub-pixels 105 and a photodiode 107. As in a conventional LCD display, sub-pixels 105 are used to display an image on panel 101. Photodiode 107 can be used to detect ambient visible light, that is, light impinging on panel 101 from external visible light sources. Conversely, photodiode 107 can be used to detect the absence of ambient visible light, which may be caused by, for example, a finger touching panel 101 and occluding ambient light from reaching photodiode 107. For this reason, optical in-LCD sensing panels are used to provide touch-based input capability to various devices.

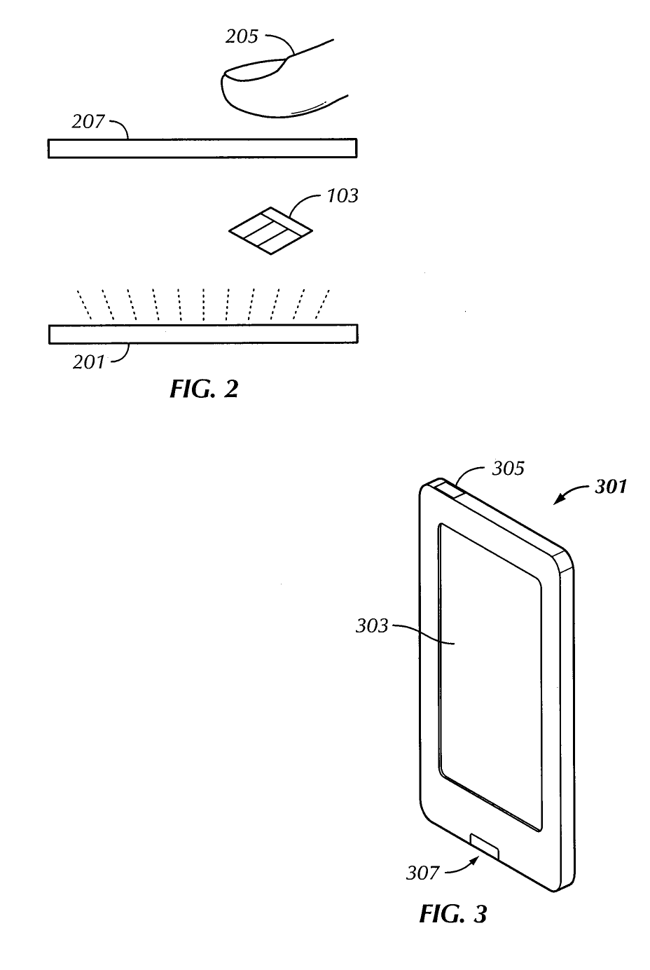

FIG. 2 illustrates the use of backlighting. In one method, the panel includes a backlight 201, and the photodetectors of pixel 103 detect light from the backlight that is reflected from a finger 205 touching a touch surface 207.

While some devices may be configured to use optical in-LCD sensing panels to detect touches on the panel, other devices can be configured to operate optical in-LCD sensing panels in different ways. An example device 301 that can include one or more embodiments of the invention will now be described with reference to FIGS. 3-9. FIG. 3 shows a perspective view of device 301, which includes an optical in-LCD sensing panel 303, an antenna 305, and a communication port 307. Antenna 305 can be used for wireless communication, such as WiFi, Bluetooth, etc., and communication port 307 can be used for wired communication, such as USB, FireWire, etc.

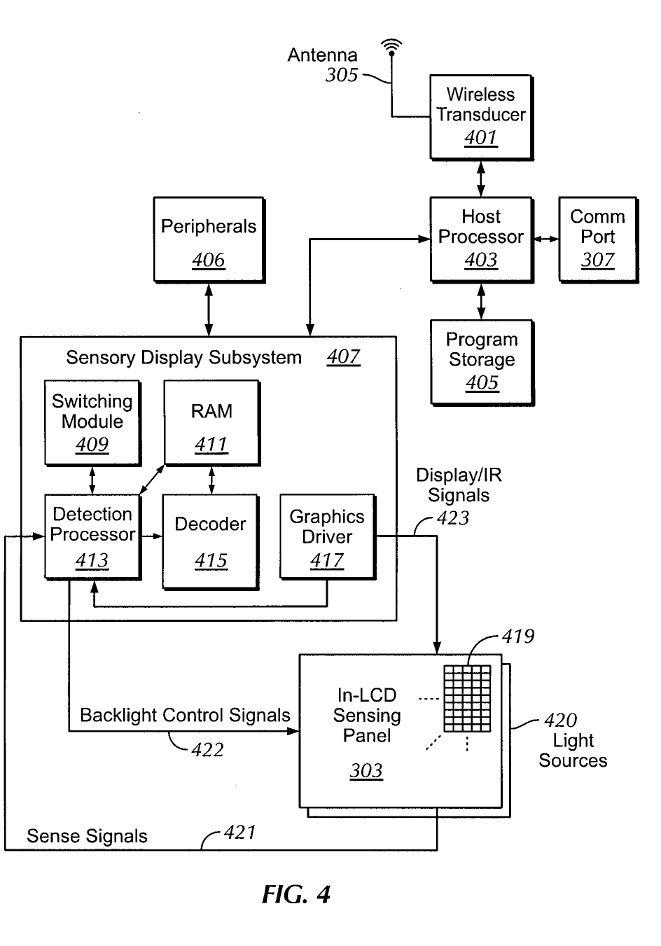

FIG. 4 is a block diagram of device 301, including optical in-LCD sensing panel 303, antenna 305, and communication port 307. Device 301 also includes a wireless transceiver 401, a host processor 403, a program storage 405, one or more peripherals 406, and a sensing display subsystem 407. Peripherals 406 can include, but are not limited to, random access memory (RAM) or other types of memory or storage, watchdog timers and the like. Sensing display subsystem 407 can include, but is not limited to, a stitching module 409, a random access memory (RAM) 411, a detection processor 413, a decoder 415, and a graphics driver 417. Optical in-LCD sensing panel 303 includes a plurality of pixels 419 and one or more internal light sources 420, such as a backlight, an LED array, a columnar light source, etc., each of which for producing a particular type of electromagnetic (EM) radiation, such as visible light, etc. The pixels include sub-pixels for displaying an image. In the present embodiment, for example, each pixel 419 includes RGB sub-pixels for emitting visible light. Pixels also include one or more EM sensors. For example, in the present embodiment each pixel 419 includes a photodiode. Of course, pixels in other embodiments may include other types of sub-pixels and EM sensors, as one skilled in the art would understand in light of the disclosure herein.

Detection processor 413 can access RAM 411, receive sensor signals 421 from panel 303, transmit control signals 422 to panel 303, and communicate with graphics driver 417, decoder 415, stitching module 409, and host processor 403. Detection processor 413 can operate to detect touch input based on sensor signals 421 and to send the detected touch input to host processor 403. Thus, panel 303 can be used as a touch screen user interface. In addition, detection processor 313 can process sensor signals 421 to obtain the other information, as described in more detail below. Graphics driver 417 can communicate with host processor 403 to receive image data of an image to be displayed, and can transmit display signals 423 to panel 303 to cause pixels 419 to display the image. For example, graphics driver 417 can display a graphical user interface (GUI) for user input when panel 303 is used as a touch screen input device.

Host processor 403 may perform actions based on inputs received from sensing display subsystem 407 that can include, but are not limited to, moving an object such as a cursor or pointer, scrolling or panning, adjusting control settings, opening a file or document, viewing a menu, making a selection, executing instructions, operating a peripheral device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 403 can also perform additional functions that may not be related to panel processing.

Note that one or more of the functions described above can be performed by firmware stored in memory (e.g. one of the peripherals 406 in FIG. 4) and executed by sensing display subsystem 407, or stored in program storage 405 and executed by host processor 403. The firmware can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

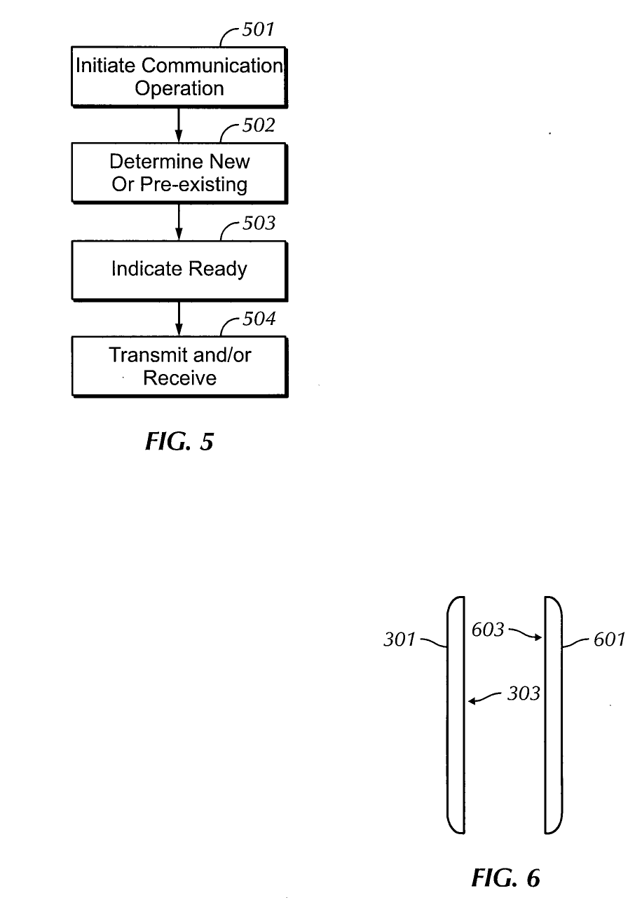

An example communication operation according to embodiments of the invention will now be described with reference to FIGS. 5-6. In the communication operation, pixels 419 are configured to communicate by displaying one or more communication images on the pixels and/or capturing one or more displayed communication images via the EM sensors. FIG. 5 is a flow chart of an example method of the communication operation. First, a user initiates (501) a communication operation mode through the GUI displayed on panel 303. Next, the process determines (502), via user input, whether the communication is a new communication or a pre-established communication. A pre-established communication may be a predetermined message or messages to be transmitted. For example, a user could set up a standard communication that transmits his or her electronic business card. Another pre-established communication may be a predetermined communication protocol to be established. For example, a user could select to transmit a particular handshaking protocol to establish a link to another device, or simply to “listen” for communications over a particular protocol or all known protocols. If the user indicates a pre-established communication, the user may be presented with a list of the pre-established communications to choose from. At 502, if the user indicates a new communication, the user may be presented with a dialog box in which to input a new message, browse to find a stored message, etc., and/or a communication protocol to use. Device 301 initiates the appropriate components and informs (503) the user when the communication is ready to be performed. For example, a message box may be displayed on panel 303 informing the user that “System ready, please position device for communication.”

FIG. 6 illustrates an example communication operation configuration according to embodiments of the invention, in which device 301 is positioned for communication with another device 601 that includes an optical in-LCD sensing panel 603. In particular, panel 303 is positioned face-to-face with panel 603.

Referring again to FIG. 5, device 301 communicates (504) with device 601 by displaying one or more communication images on panel 303 and/or capturing one or more communication images displayed on panel 603. Communication images are displayed as visible images using visible light sub-pixels. The visible communication images are captured with the photodiodes.

Communication by displaying and capturing images with an optical in-LCD sensing panel can take a variety of forms. Communication may be one-way, for example, a first device transferring data, such as an electronic business card, to a second device. Communication may be bidirectional, for example, a first communication image displayed by a first device may be captured by the sensors of a second device, and vice versa over the course of a data transmission. Communication may be encoded in a variety of different ways. For example, a communication image may be an image of text that could be captured and read directly by the recipient with minimal processing. Communication of an image of text may provide an easy way to communicate information between electronic devices without the need for particular protocols or predetermined coding schemes to be coordinated beforehand. In addition, the captured image of text may be processed using, for example, optical character recognition (OCR). In other forms, a communication image may be a coded visual structure, such as a one-dimensional barcode, a QR code, which is essentially a two-dimensional barcode, etc. Using QR codes for communication images may allow more flexibility in the positioning of the communicating devices, because QR codes can allow reading at different angles/orientations.

The data transfer could be done asynchronously, that is, without any synchronization between the devices. In another embodiment, the data transfer could be synchronous. For example, the devices could be synchronized to a common clock, such as a GPS satellite clock, and then the data transfers could occur by displaying/capturing at predetermined times. This might allow the devices to reject or reduce some noise in a similar way that synchronous modulation is used to reduce noise in other applications.

In another form of communication, a black and white image displayed by a first device, for example, might be captured by the display of a second device and interpreted as if the black areas are occluded areas and the white areas are non-occluded areas (e.g., as if the device was reading ambient light). In this case, black areas may be interpreted as a “touches” on the display of the second device. Thus, this form of communication might be used, for example, to perform “touch” inputs, e.g., a single touch, a multiple touch, a gesture, etc., on the second device. Each “touch” input may be received by a GUI displayed on the second device and interpreted as a user input, for example, pressing a button, scrolling a scrollbar, selecting from a list, typing in text, double-clicking an icon, etc. A series of “touch” inputs (i.e., communication images representing touch inputs) may be stored in a memory of the first device and, similar to a macro, may be used to automatically perform a series of tasks on another device. However, unlike a conventional macro, a communication image macro could be entered directly into the second device's GUI without the need to communicate the macro to the second device by other channels of communication. This may be helpful, for example, to automate diagnostic and testing routines, particularly when the testing device and the device under test (DUT) cannot communicate by other means, e.g., the DUT's WiFi is malfunctioning, the communication cable cannot be found, etc. Although the example of black-and-white images is used, other types of images, such as color images, etc., could be used so long as the image would be interpreted as the intended “touch” by the second device, as one skilled in the art would recognize in light of the present disclosure.

Referring again to FIG. 6, device 301 and device 601 are shown positioned relatively close to one another, approximately one inch apart, with their respective panels 303 and 603 substantially parallel and aligned with each other. However, communication may be effective when the devices are in other positions. The effectiveness of communication may depend on the form of communication used. Using the configuration shown in FIG. 6 as an example starting point for the purpose of illustration, in some embodiments one of the devices may be rotated (in the plane of its panel) with respect to the other, particularly if the communication images have some degree of rotational symmetry, e.g., a communication image having circular symmetry would appear the same at any rotational angle. As mentioned above, some types of communication images, such as QR codes, may allow a greater latitude in positioning the devices; again using the FIG. 6 example, in this case, one of the devices may be rotated (out of the plane of its panel) with respect to the other.

The effective range of communication (i.e., maximum distance between the two panels) might vary from substantially zero (i.e., the panels are touching) to a distance at which an error rate of the communication becomes unacceptable. Of course, the range of communication may increase or decrease depending on, for example, the form of communication used, including the type of communication images, the EM spectrum used, such as black/white, color, the rate of display of the images, the resolution and/or size of the displayed images, etc. The range of communication may also vary depending on, for example, the physical parameters of the devices, such as panel resolution, brightness, size, sensor sensitivity, etc., and/or external factors, such as the brightness and/or color of ambient light, electromagnetic interference, mechanical vibration of the device, etc.

In other words, the positioning of the devices, along with other factors such as those listed above, may affect the error rate of the communication between the devices. For example, moving the devices further apart may increase the error rate, while reducing the brightness of the ambient light may decrease the error rate.

In some embodiments, the communication operation can sense an error rate of communication and can modify one or more factors affecting the error rate to either increase or decrease the error rate, depending upon a desired result. Some embodiments may detect error rate by, for example, including an error detection code, such as a cyclic redundancy check code (CRC) in the data transfer, and may modify one or more system parameters in order to maintain the detected error rate within a predetermined range. If the detected error rate exceeds the upper bound of the predetermined range, the resolution/size of the displayed communication images may be modified by decreasing the resolution and/or increasing the size. For example, displaying a single “dot” that covers the entire panel (i.e., using the entire panel to display one “pixel”) as a communication image may result in a lower error rate/longer range of communication versus using a higher resolution (more detailed) communication image. However, the effective bandwidth of the communication may also be reduced because only one bit of information would be displayed/captured at a time. Conversely, if the detected error rate drops below the lower bound of the predetermined range, communication image resolution may be increased in order to increase the bandwidth of the communication.

In another embodiment, other factors that affect communication may be detected and the system may adjust accordingly. In one example, if the device senses that the intensity of ambient light is high (e.g., in a brightly lit room, outside in direct sunlight), the device can increase the brightness/contrast of the display panel to increase the readability of displayed communication images. On the other hand, if the intensity of ambient light is low, the device can decrease the brightness/contrast of the display panel to save power.

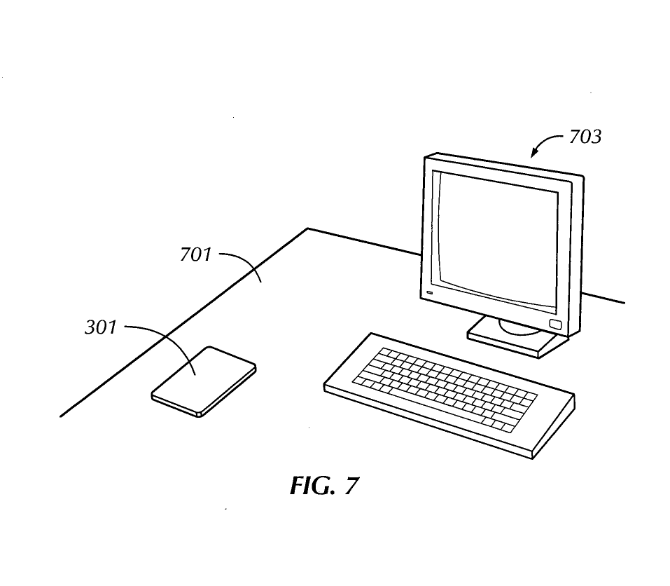

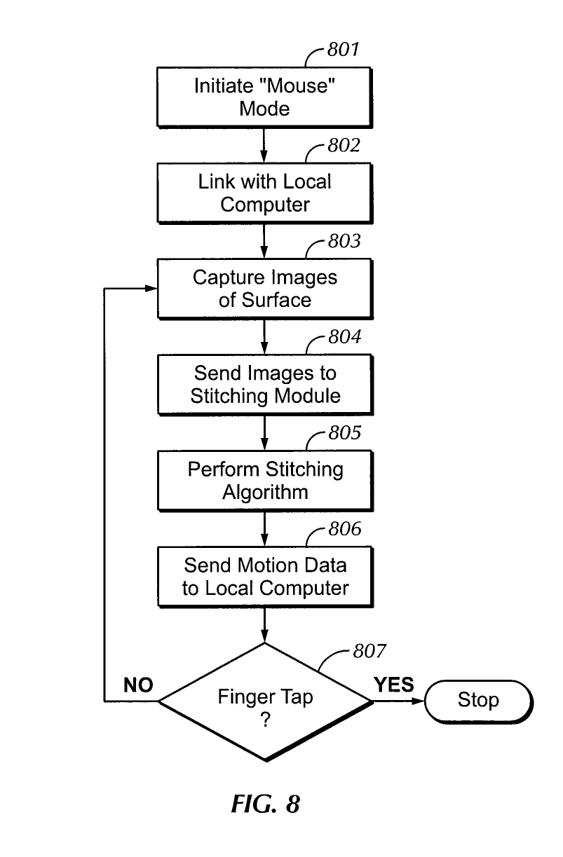

FIG. 7 shows an example method of input according to embodiments of the invention. Device 301 is placed on a surface 701 with panel 303 face down, so that sensors 107 can capture images of surface 701 at predetermined times. FIG. 8 is a flow chart of an example mode of operation according to embodiments of the invention, in which the configuration shown in FIG. 7 can operate as a user input device similar to a computer mouse. Before placing device 301 face down, a user selects (801) a “mouse” mode via a GUI on panel 303, and then places the device face down on surface 701. In mouse mode, device 301 links (802) with a local computer 703 (see FIG. 7), for example, via a wireless connection through antenna 305, a wired connection through communication port 307, etc. Sensors 107 capture (803) images of surface 701 at predetermined times, and the images are sent (804) to stitching module 409 (see FIG. 4). Stitching module 409 performs (805) a stitching algorithm that compares the images to determine the relative position of device 301 corresponding to each image and determines the motion of device 301 from the position data. Device 301 sends (806) motion data of the device to computer 703. The motion data can be used by computer 703 to move a mouse icon on a display of the computer in correspondence with the motion of device 301. The process can continue until a stop command has been generated; for example, device 301 can generate a stop command when the device senses (807) a finger tap input on panel 303 after being lifted from surface 701.

In other embodiments, the stitching operation can be performed externally. For example, rather than sending the images of surface 701 to stitching module 409, the images can be sent directly to computer 703, which would process the images internally.

It is noted that, unlike a conventional computer mouse, the position data generated by the foregoing example operation can include information about the rotational motion of device 301, in addition to information about the translational motion of the device. The rotational motion data may be useful in applications such as, for example, computer games.

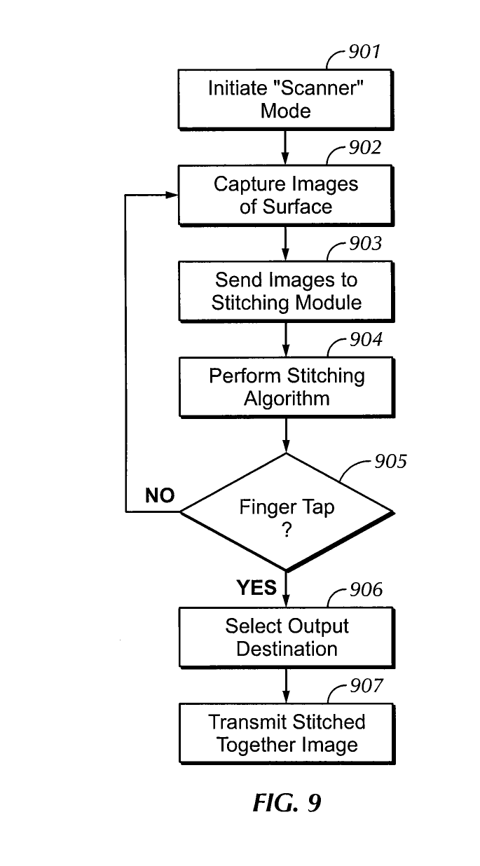

FIG. 9 is a flowchart of another example mode of operation according to embodiments of the invention, in which the configuration shown in FIG. 7 can operate as a handheld surface scanner. Before placing device 301 face down, a user selects (901) a “scanner” mode via a GUI on panel 303, and then places the device face down on surface 701. Sensors 107 capture (902) images of surface 701 at predetermined times, and the images are sent (903) to stitching module 409 (see FIG. 4). Stitching module 409 performs (904) a stitching algorithm that stitches the images together. The process can continue until a stop command has been generated; for example, device 301 can generate a stop command when the device senses (905) a finger tap input on panel 303 after being lifted from surface 701. The user then selects (906) the output destination of the stitched-together image, and the image is transmitted (907). For example, the user may select to have the image transmitted wirelessly via antenna 305, transmitted through a wired connection via communication port 307, stored in local memory storage, such as program storage 405, RAM 411, etc.

In contrast to conventional handheld scanners, the foregoing example scanner mode may not require the user to maintain a constant velocity when moving the device across the surface to be scanned because, for example, the stitching algorithm can determine the motion of device 301 and compensate for the motion when stitching together the images. In addition, conventional handheld scanners typically require the user to move the scanner in a straight line across a page, and to refrain from rotating the scanner. In contrast, in the foregoing example, the user would be free to move the device freely around on the page in practically any manner, e.g., the device could be rotated, move along an irregular path, moved at different speeds and directions, and the device would be able to compensate for the regular motion and to generate a scanned image as the user “paints” the page with the device.

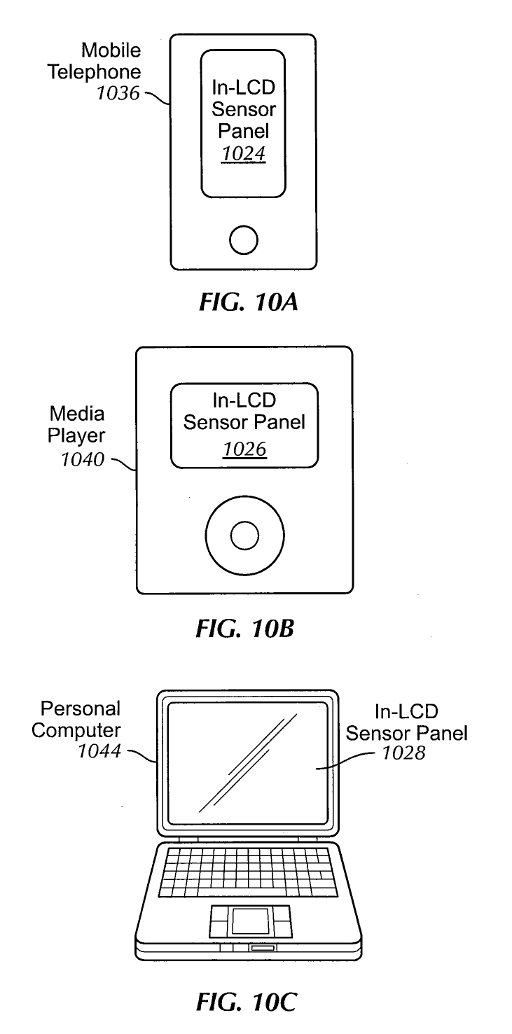

FIG. 10a illustrates example mobile telephone 1036 including an optical in-LCD sensing panel 1024 and configured to operate according to embodiments of the invention.

FIG. 10b illustrates example digital media player 1040 including an optical in-LCD sensing panel 1026 and configured to operate according to embodiments of the invention.

FIG. 10c illustrates exemplary personal computer 1044 including an optical in-LCD sensing panel 1028 and configured to operate according to embodiments of the invention. The mobile telephone, media player and personal computer of FIGS. 10a, 10b and 10c can achieve improved overall reliability by utilizing the improved reliability traces according to embodiments of the invention.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A method of communication for a device having an optical in-LCD sensing panel, which includes a plurality of display pixels and a plurality of embedded electromagnetic (EM) sensors, the method comprising:
transmitting first data from the device by displaying, on the plurality of display pixels, a first communication image encoding the first data; and
receiving second data into the device by capturing, with the EM sensors, a second communication image encoding the second data, the second communication image being displayed in proximity to the sensing panel.

2. The method of claim 1, wherein the display pixels include RGB subpixels, and the EM sensors include photodiodes.

3. The method of claim 1, wherein the first data is text data, the method further comprising:
encoding the first data into the first communication image as an image of the text data.

4. The method of claim 1, further comprising:
encoding the first data into the first communication image as a QR code.

5. The method of claim 1, wherein the first data represents one or more touch inputs.

6. The method of claim 1, further comprising:
decoding the second communication image to obtain the second data.

7. The method of claim 1, further comprising:
sensing an error rate of communication; and
adjusting the error rate to within a predetermined range of error rate, if the sensed error rate is outside of the range, by modifying a parameter of the device.

8. A method of transferring data between a first device and a second device, each device having a display that includes an array of optical sensors, the method comprising:
displaying an image on the display of the first device, the image corresponding to data to be transferred; and
detecting the displayed image with the array of optical sensors in the display of the second device to obtain a detected image.

9. The method of claim 8, wherein the data is text data, and the image encodes the data as an image of the text data, the method further comprising:
processing the detected image in the second device using optical character recognition.

10. The method of claim 8, wherein the image encodes the data as a QR code.

11. The method of claim 8, wherein the data represents one or more touch inputs, the method further comprising:
processing the detected image to enter the one or more touch inputs into a user interface of the second device.

12. The method of claim 8, further comprising:
sensing an error rate of communication; and
adjusting the error rate to be within a predetermined range of error rate, if the sensed error rate is outside of the range, by modifying a parameter of the second device.

13. An apparatus for communicating data with an external device, the apparatus comprising:
a display;
an array of electromagnetic (EM) sensors embedded in the display; and
a receiver that receives data by reading an external communication image displayed on the external device, wherein the array of EM sensors detects the external communication image and sends image detection signals to the receiver, and the receiver converts the image detection signals into the received data.

14. The apparatus of claim 13, wherein the EM sensors include photodiodes.

15. The apparatus of claim 13, wherein the data represents one or more touch inputs, the apparatus further comprising:
a user interface that interprets the received data as the one or more touch inputs.

16. An apparatus for communicating data with an external device, the apparatus comprising:
a display;
a first array of optical sensors embedded in the display;
a transmitter that transmits data by processing data to be transmitted into a communication image that is readable by a second array of optical sensors in the external device, and displaying the communication image on the display; and
a receiver that receives data by reading an external communication image displayed on the external device, wherein the first array of optical sensors detects the external communication image and sends image detection signals to the receiver, and the receiver converts the image detection signals into the received data.

17. The apparatus of claim 16, wherein the data is text data, and the communication image encodes the data as an image of the text data.

18. The apparatus of claim 16, wherein the communication image encodes the data as a QR code.

19. The apparatus of claim 16, wherein the data represents one or more touch inputs.

20. A system for transferring data comprising:
a first device including
a first display that includes a first array of optical sensors, and
a first processor that generates an image on the first display, wherein the data to be transferred is represented by the image; and
a second device including
a second display that includes a second array of optical sensors that detects the image displayed on the first display and generates image detection signals, and
a second processor that converts the image detection signals into transferred data.

21. A method of determining a motion of a handheld device having a display that includes an embedded array of electromagnetic (EM) sensors, the method comprising:
scanning a surface with the array of EM sensors at a first time to obtain a first scan image;
scanning the surface with the array of EM sensors at a second time to obtain a second scan image; and
comparing the first scan image and the second scan image to obtain the motion of the handheld device.

22. The method of claim 21, further comprising:
transmitting, to an external device, a control signal based on the motion of the handheld device.

23. The method of claim 22, wherein the external device includes a display that displays a user-controllable element, and the control signal is configured to control the user-controllable element.

24. The method of claim 23, wherein the user-controllable element is a cursor.

25. The method of claim 21, further comprising:
combining a portion of the first scan image with a portion of the second scan image based on the motion of the handheld device to generate a combined scan image of the surface.

26. An apparatus for generating a control signal comprising:
a display;
an array of electromagnetic (EM) sensors embedded in the display;
a scanning module that scans a surface with the array of EM sensors to obtain a plurality of scan images;
a comparing module that compares the scan images; and
a transmitter that transmits a control signal based on a result of the comparison.

27. The apparatus of claim 26, wherein the transmitter transmits the control signal to an external device.

28. The apparatus of claim 27, wherein the external device includes a display that displays a user-controllable element, and the control signal is configured to control the user-controllable element.

29. The apparatus of claim 28, wherein the user-controllable element is a cursor.

30. The apparatus of claim 26, further comprising:
a combiner that combines a portion of the first scan image with a portion of the second scan image based on the control signal to generate a combined scan image of the surface.

31. The apparatus for generating a control signal of claim 26, the apparatus incorporated within a computing system.

32. A mobile telephone including an apparatus for generating a control signal, the apparatus for generating a control signal comprising:
a display;
an array of electromagnetic (EM) sensors embedded in the display;
a scanning module that scans a surface with the array of EM sensors to obtain a plurality of scan images;
a comparing module that compares the scan images; and
a transmitter that transmits a control signal based on a result of the comparison.

33. A digital media player including an apparatus for generating a control signal, the apparatus for generating a control signal comprising:
a display;
an array of electromagnetic (EM) sensors embedded in the display;
a scanning module that scans a surface with the array of EM sensors to obtain a plurality of scan images;
a comparing module that compares the scan images; and
a transmitter that transmits a control signal based on a result of the comparison.
